(19) United States
(12) Patent Application Publication
(10) Pub. No.: US 2014/0266670 A1
(43) Pub. Date: Sep. 18, 2014

(54) Home Surveillance and Alert triggering system

(71) Applicant: HCL Technologies Limited, Chennai (IN)

(72) Inventors: Shashidhar Krishnamoorthy, Noida (IN); Sachin Gangwar, Noida (IN); Mayank Babu Rastogi, Noida (IN)

(73) Assignee: HCL Technologies Limited, Chennai (IN)

(21) Appl. No.: 13/950,290

(22) Filed: Jul. 25, 2013

(30) Foreign Application Priority Data
Mar. 15, 2013 (IN) 1144/CHE/2013

(51) Int. Cl. G08B 23/00

(52) U.S. Cl. CPC G08B 23/00
USPC 340/501

(57) ABSTRACT

The embodiments herein relate to security systems and, more particularly, to a system for automated surveillance and alert triggering. Input devices such as sensors, camera are positioned in a building to be monitored. A gateway module receives and processes inputs from the input devices and checks for occurrence of any event. Upon detecting any event, the gateway module sends information related to the detected event to a configured user device. Further, the gateway records audio and/or video contents related to the detected event and store the recorded data in an associated memory module. The user can remotely access and view the stored contents and can trigger any pre-configured action remotely from the user device.

### PRIORITY DETAILS

The present application is based on, and claims priority from, Indian Application Number 1144/CHE/2013, filed on 15^{th} Mar., 2013, the disclosure of which is hereby incorporated by reference herein.

### TECHNICAL FIELD

The embodiments herein relate to security systems and, more particularly, to a system for automated surveillance and alert triggering.

### BACKGROUND OF EMBODIMENT

Surveillance systems have become one of the major necessities in today's world. These systems are helpful from various perspectives such as home security, Kids/old age parents monitoring and so on. For example, home robberies and associated crimes are increasing day by day, making living of public difficult. Though various security systems are available in market, they are not useful some times as they fail to provide any kind of instant alert or evidence in case of a robbery or robbery attempt.

Further, in most of the families in which husband and wife are working people, it is quite tough to manage kids and old aged parent at home. For example, old aged people may suffer from any physical issues which require immediate medical attention. If there is no one at home at that time, the result may be tragic. Similarly, the parents have to ensure whether are reaching home on time from school everyday. In another case, assume a visitor comes for any specific purpose when there is no one at home. In this scenario, the homeowner may not be able to know who had come at his/her home. All these require continuous monitoring, which is again not possible during tight schedules at work place or some similar places. None of the existing systems provides a mean for timely alerts and interactive surveillance systems.

### SUMMARY

Embodiments herein disclose a method of automated surveillance and alert triggering in a building, said method comprises detecting occurrence of at least one event in said building; sending information on said detected event to a user; recording and data related to said detected event; collecting additional data related to said detected event using a self-learning feature; storing said recorded data and said collected additional data in a memory module; and triggering at least one action corresponding to said detected event.

Also, disclosed herein is a system for automated surveillance and alert triggering in a building, said system configured for detecting occurrence of at least one event in said building; sending information on said detected event to a user; recording and data related to said detected event; collecting additional data related to said detected event using a self-learning feature; storing said recorded data and said collected additional data in a memory module; and triggering at least one action corresponding to said detected event.

### BRIEF DESCRIPTION OF THE FIGURES

The embodiments herein will be better understood from the following detailed description with reference to the drawings, in which:

FIG. 1 illustrates block diagram that shows architecture of the surveillance and monitoring system, as disclosed in the embodiments herein;

FIG. 2 is a block diagram that shows various components of the gateway module, as disclosed in the embodiments herein; and

FIG. 3 is a flow diagram that shows various steps involved in the process of monitoring events in a home using the surveillance and monitoring system, as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a home surveillance and alert triggering using surveillance and monitoring system. Referring now to the drawings, and more particularly to FIGS. 1 through 3, where similar reference characters denote corresponding features consistently throughout the figures, there are shown embodiments.

FIG. 1 illustrates block diagram that shows architecture of the surveillance and monitoring system, as disclosed in the embodiments herein. The system comprises a gateway module 101, a video management server 102, an input device 103 and a user device 104. The input device 103 refers to a plurality of sensors and camera that are placed in various locations of the house/building under surveillance. For example, a sensor may be attached to the door so as to sense any attempt to open the door, another sensor that is connected to a calling bell so as to sense any person using the calling bell, sensors attached to windows which can sense any attempt to break open the windows, plurality of motion sensors to sense movements in rooms and so on. Similarly camera positioned near main entrance and other suitable locations in the home can record videos/images continuously or when specific events occur.

The input devices 101 feeds sensed or measured data to the gateway module 102. The gateway module 102 processes received data and checks if any specific event has occurred or not. In various embodiments, the event may be a visitor pressing the calling bell, an attempt to forcefully open a door/window, lack of movement in a room in case of old age monitoring and so on. If occurrence of any of event is detected, the gateway module 101 alerts the user, preferably by sending a message in any suitable format to the user device 104. In a preferred embodiment, the user device 104 has to be configured with the gateway module 101 to receive the alert.

In a preferred embodiment, in addition to alerting the user, the gateway module 101 also records a series of images or a video associated with the event for a fixed time with the help of associated camera and other devices. Further, the recorded data is uploaded and stored in the content management server 102 along with corresponding date and time stamps. In another preferred embodiment, the gateway module 101 performs a data analysis and correlation process during which the system manages to collect information related to the person who visits the house, from associated databases such as social networking websites. The user can access the stored data from a remote location using the user device 104 and can trigger certain actions. For example, if the user wants to communicate with the person who is visiting his home, he can initiate an audio or video communication session from the user device 104 with the help of a communication interface in the gateway module 101.

FIG. 2 is a block diagram that shows various components of the gateway module, as disclosed in the embodiments herein. The gateway module 101 further comprises an Input/output (I/O) module 201, a processing module 202, a memory module 203, a communication interface 204, a backend streaming engine 205, a system clock 206, a data analytics engine 207 and a control module 208. The I/O module 201 acts as an interface that connects various input devices 103, user device 104, content management server 102 and response module 105 to the gateway module 101 for exchange of data and control signals.

The processing module 202 processes the data received from various input devices 101, user device 104 and so on and may convert the received data to a standard format. For example, inputs from various sensors and camera may be in different formats. These data have to be converted to a specific format for further processing. The memory module 203 may be used to store data such as user device configuration information, alert configured, social networking login information and so on, which are required for functioning of the system. The memory module 203 may also store data recorded using associated camera and other inputs upon occurrence of an event. For example, if the gateway module 101 loses connection with the content management server 102 due to any technical issue, the memory module 203 may be used as a temporary storage medium.

The communication interface 204 may be used by the user to remotely initiate a communication session with a person who visits the house when the user and his family are not in the house. In various embodiments it may be an audio or a video session. The backend streaming engine 205 may be used to stream contents such as audio, video, image and so on stored in the content management server 102 or the memory module 203 when the user attempts to access the data from the user device 104. The system clock 206 can be used to add time and date stamp with each session of data being recorded and stored in the content management server 102 or the memory module 203 upon occurrence of an event.

The data analytics engine 207 can be used to analyze data being captured using the associated input devices such as camera and get more information from associated databases. For example, when a person visits the house under surveillance, the camera connected to the gateway module 101 records video and/or images of the person. The data analytics engine 207 performs a video or image analysis and correlation, searches in configured databases such as social networking websites and fetches and stores the additional information that may reveal identity of the visitor.

The control module 208 is used to trigger any specific action based on a user command. For example, if the visitor is a known person, the user may trigger a command to open door of the home remotely. The control module 208 may then execute the action based on the user command received from the user device 104.

FIG. 3 is a flow diagram that shows various steps involved in the process of monitoring events in a home using the surveillance and monitoring system, as disclosed in the embodiments herein. After installing the surveillance and monitoring system in the house, the user can turn on/activate the system when he is going out or else as and when it is required. The gateway module 101 receives (301) inputs from associated sensors, camera and other input devices 103. The gateway module 302 processes (302) the received data and checks (303) whether any event has occurred or not. In various embodiments, the event may be a visitor pressing the calling bell, an attempt to forcefully open a door/window, lack of movement in a room in case of old age monitoring and so on. In various embodiments, the gateway module 101 may detect an event by separately processing inputs from various input devices or by a combined analysis of multiple inputs.

Upon detecting an event, the gateway module 101 sends (304) information regarding the detected event to the user device 103. In an embodiment, the user device 103 has to be pre-configured with the gateway module 101 so as to receive the information and for exchange of any data or control signal each other. The user device 103 may be a mobile phone, a laptop, a tablet PC or any such compatible device. In addition to sending the information to the configured user device 103, the gateway module records data such as audio/video/image related to the detected event using associated input devices 103.

In a preferred embodiment, the gateway module 101 performs a data analytics and correlation to extract more information about the detected event or a subject in the occurred event. For example, when a person visits the house under surveillance, the camera connected to the gateway module 101 records video and/or images of the person. Further, the data analytics engine 207 in the gateway module 101 analyzes the captured video or image, searches in configured databases such as social networking websites and fetches and stores the additional information that may reveal identity of the visitor. The recorded data and the additional information fetched during the data analytics and correlation process is uploaded and stored (305) in the content management server 102. In another embodiment, the data may be stored in the memory module 203 associated with the gateway module 101.

Further, upon getting the event information, the user can access the data corresponding to the event, stored in the content management server 102 and/or the gateway module 101 remotely using the configured user device 104. When the user accesses the data, the video, audio or images may get streamed on a backend streaming engine 205 associated with the gateway module 101. In another embodiment, the audio, video or image content may get downloaded to the user device 104. The recorded content may help the user to confirm whether the detected event is genuine or not.

Further, based on the event, the user can trigger certain action using the configured user device 104. Upon receiving the user command, the control module 208 in the gateway module 101 is used to triggers the specific action based on the received user command. For example, if the visitor is a known person, the user may trigger a command to open door of the home remotely. The control module 208 may then execute the action based on the user command received from the user device 104. The various actions in method 300 may be performed in the order presented, in a different order or simultaneously. Further, in some embodiments, some actions listed in FIG. 3 may be omitted.

Mentioned below are some examples in which operation of the surveillance and monitoring system under various situations are explained.

### Example 1

### A Visitor Coming in when the Home Owner is in/Out the Home

When the visitor presses door bell, a sensor associated with the door bell sends information to the gateway module 101 and information regarding this event is sent as a notification to the user's configured user device 104. Further, a short clip or a series of images is captured using the camera and this data is uploaded and stored in the content management server 102. The gateway also performs a data analysis and correlation to obtain more information regarding the visitor. The user can view this data using the user device 104. The user can also initiate a video/audio session to communicate with the visitor. Further, the user can remotely send a command to open the door if the visitor is a trusted person. Or else, the user can ask the visitor to come some other time.

### Example 2

### Intruder Comes Home with/without Break in

The user can activate the system while going out. Upon activation of the system, motion sensor, door sensor and window sensors deployed in the house get activated. If the intruder comes in by breaking the door, the door sensor detects the event. If the intruder sneaks in without any break in, the motion sensor and/or window sensor detects the event.

Further, a notification regarding occurrence/detection of the event is sent to the user's configured user device 104. Further, a short clip or a series of images is captured using the camera and this data is uploaded and stored in the content management server 102. In an embodiment, the short clip or a series of images prior to and after occurrence of the event are recorded. The user can access the data stored in the content management server 102 from the user device 104 and can raise an alarm to notify others.

### Example 3

### Old Aged People and Kids Management

When the old age people management is activated, the system checks for movements in various rooms using associated sensors. If movement is not detected in any of the rooms for a pre-determined period of time, the gateway module 101 sends a notification regarding occurrence/detection of the event is sent to the user's configured user device 104. Further, a short clip or a series of images is captured using the camera and this data is uploaded and stored in the content management server 102. The user can access the data stored in the content management server 102 from the user device 104 and can take necessary actions. In another embodiment, input to the gateway module 101 may be a manually triggered alert by the old age person using an emergency alarm bracelet. Similarly, the system may be used for kid's management which helps the user to monitor and ensure safe arrival of kids at home.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for home surveillance and alert triggering. The mechanism allows event based alert triggering in a surveillance system, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of automated surveillance and alert triggering in a building, said method comprises:
detecting occurrence of at least one event in said building;
sending information on said detected event to a user;
recording and data related to said detected event;
collecting additional data related to said detected event using a self learning feature;
storing said recorded data and said collected additional data in a memory module; and
triggering at least one action corresponding to said detected event.

2. The method as in claim 1, wherein said detecting occurrence of the event further comprises:
fetching at least one of a plurality of inputs from a plurality of input devices; and
analyzing said fetched input data.

3. The method as in claim 1, wherein said information is sent to a pre-configured user device.

4. The method as in claim 1, wherein said additional data is collected from at least one of a plurality of web resources.

5. The method as in claim 1, wherein said action corresponding to said detected event is pre-configured.

6. The method as in claim 1, wherein said action corresponding to said detected event is automatically triggered.

7. The method as in claim 1, wherein said action corresponding to said detected event is manually triggered.

8. The method as in claim 7, wherein said plurality of web resources is pre-configured.

9. The method as in claim 1, wherein said plurality of input devices further comprises at least one of a door bell sensor, a camera, a door sensor, a window sensor and a motion sensor.

10. The method as in claim 1, wherein said detected event is at least one of a visitor pressing a calling bell, an attempt to open window or door of said building, old age monitoring or child monitoring.

11. The method as in claim 10, wherein said triggering alert based on a visitor pressing a calling bell further comprises:
sensing said calling bell press event using a sensor;
sending an information regarding said detected event to said user device;
recording at least one of a video or audio data corresponding to said sensed event;
collecting additional data related to said visitor using said self learning feature;
uploading said recorded data and said additional data to said storage module; and
triggering said action corresponding to the detected event.

12. The method as in claim 10, wherein said triggering alert based on an attempt to open window or door of said building further comprises:
sensing at least one of said window or door opening event;
sending an information regarding said detected event to said user device;
recording at least one of a video or audio data corresponding to said sensed event;
uploading said recorded data to a storage module; and
triggering said action corresponding to the detected event.

13. The method as in claim 10, wherein said triggering alert based on old age monitoring further comprises:
detecting movements in a selected room in said building;
sending an information to said user device on said movement being not detected for a specific period of time;
recording at least one of a video or audio data from said selected room;
uploading said recorded data to a memory module; and
triggering said action corresponding to the detected event.

14. A system for automated surveillance and alert triggering in a building, said system configured for detecting occurrence of at least one event in said building;
sending information on said detected event to a user;
recording and data related to said detected event;
collecting additional data related to said detected event using a self-learning feature;
storing said recorded data and said collected additional data in a memory module; and
triggering at least one action corresponding to said detected event.

15. The system as in claim 14, wherein said system is configured for detecting occurrence of the event by:
fetching at least one of a plurality of inputs from a plurality of input devices; and
analyzing said fetched input data.

16. The system as in claim 14, wherein said system is configured for sending said information to a pre-configured user device.

17. The system as in claim 14, wherein said system is configured for collecting said additional data from at least one of a plurality of web resources.

18. The system as in claim 14, wherein said system is configured for pre-configuring said action corresponding to said detected event.

19. The system as in claim 14, wherein said system is configured for automatically triggering said action corresponding to said detected event.

20. The system as in claim 14, wherein said system is configured for manually triggering said action corresponding to said detected event.
